(19) United States
(12) Patent Application Publication
(10) Pub. No.: US 2015/0218849 A1
(43) Pub. Date: Aug. 6, 2015

(54) METHOD FOR PRODUCING A ONE-PIECE LOCK STRIKER

(71) Applicant: KIEKERT AKTIENGESELLSCHAFT, Heiligenhaus (DE)

(72) Inventors: Thomas Waldmann, Mulheim Ruhr (DE); Frank Nieddu, Dusseldorf (DE)

(73) Assignee: Kiekert Aktiengesellschaft, Heiligenhaus (DE)

(21) Appl. No.: 14/426,401

(22) PCT Filed: Sep. 5, 2013
(86) PCT No.: PCT/DE2013/000514

§ 371 Date: Mar. 6, 2015

(30) Foreign Application Priority Data
Sep. 8, 2012 (DE) 10 2012 017 841.7

(51) Int. Cl. E05B 15/02; C21D 8/00; C21D 9/00; C21D 6/00; B21J 5/08; C22C 38/22; C22C 38/44; C22C 38/12; C22C 38/04; E05B 85/04; C22C 38/32

(52) U.S. Cl. CPC E05B 15/0295; E05B 85/045; C21D 8/005; C21D 9/0068; C21D 6/002; C21D 6/004; C21D 6/005; C22C 38/32; C22C 38/22; C22C 38/44; C22C 38/12; C22C 38/04; B21J 5/08

(57) ABSTRACT

The invention relates to a method for producing a one-piece lock striker and to a lock striker produced according to said method. The lock striker (1) comprises a base plate (1) and a lock bracket (3). A metal starter blank (11) is formed into a lock striker by cold forming, in particular by cold upsetting. The starter blank (11) is substantially block-shaped or cylindrical and is formed in such a way that the lock striker (1) becomes strain-hardened.

### CROSS-REFERENCE TO RELATED APPLICATIONS

This application is the U.S. national stage application of International Patent Application No. PCT/DE2013/000514, filed Sep. 5, 2013, which claims priority of German Application No. 10 2012 017 841.7, filed Sep. 8, 2012, which are both hereby incorporated by reference.

### BACKGROUND

The invention relates to a method for producing a one-piece lock striker according to the generic part of claim 1 and a lock striker produced according to this method.

Said lock strikers can be found, in particular, in motor vehicle locks and locking mechanisms. Below, the invention is explained with reference to the area of application of the motor vehicle locks, although the invention is not restricted to this.

A lock striker usually comprises a base plate and a lock bracket, also referred to as locking bolt or lock striker bracket. The base plate typically contains openings in form of e.g. holes to allow, for instance fixing of the lock striker to the body of a motor vehicle. The lock bracket is shaped in such a way that it contains a centre opening so that, when installed, the lock bracket interacts with a lock or locking mechanism. The lock striker can thus, in the closed state of a motor vehicle door or flap be in a retaining engagement with a rotary latch of a lock or similar in order to securely close a flap or door of a vehicle.

A motor vehicle lock generally contains a locking mechanism comprising a rotary latch and at least one pawl by means of which a rotation of the rotary latch in opening direction can be blocked.

As a result of the engagement between the lock striker and the rotary latch during the closing operation but also during opening of the lock, a lock striker is regularly exposed to high stressing. This is, in particular, the case in the event of a crash, resulting in particularly severe deformation.

A one-piece lock striker is usually produced by solid forming of a starter material—i.e. a blank—by cold extrusion or cold upsetting. Publication DE 10 2007 041 479 A1 discloses a one-piece lock striker for a motor vehicle closing system, in form of a solid component with cross sections of different thicknesses in order to achieve a better production and improved mechanical characteristics.

Publication DE 10 2010 024 510 A1 discloses a method for the production of a lock striker, in which raw material is first sheared off and is then heated to processing temperatures above the recrystallisation temperature for hot forming, after which it is formed into a lock striker by compressive forming using forging hammers.

Publication DE 10 2010 011 716 Al discloses a method for the production of a lock striker, in which a T-shaped semi-finished product is formed from a raw material by cold extrusion. The lock striker can be formed from a round raw material to a T-shaped semi-finished product by solid forming. The T-shaped semi-finished product is then, for instance, processed further by cold stamping, in order to provide fixing holes in the base plate and an opening in the lock bracket. The method is designed to save on complex reworking of the lock striker.

The as yet unpublished DE 10 2010 054 369 discloses a method for producing lock strikers, in which a T-shaped semi-finished product is formed by cold extrusion and in which subsequently fixing holes and openings are formed by stamping. In addition, a material bead is arranged on the leg of the lock bracket parallel to the base plate in order to produce a trailing edge during forming into a T-shaped semi-finished product. The trailing edge serves, in the first instance, to prevent a deformation and catching of the lock plate in the event of a crash so that a motor vehicle lock can still be reliably opened.

The forming process based on plastic changing of a specified solid starter blank is generally associated with the problem that considerable forming forces are required, which also considerably stress the tool. Furthermore, large machines such as presses are required for providing said considerable forming forces.

### SUMMARY

Unless specified differently below, the aforementioned characteristics can be combined individually or in any combination with the object of the invention described below.

It is the task of the invention to further develop the production of a lock striker.

The task of the invention is solved by a method with the characteristics of claim 1. Advantageous embodiments are disclosed in the sub claims.

According to the method of the invention, a lock striker is formed from a metal starter blank by cold forming and, in particular, cold upsetting. Prior to the forming process, the starter blank is essentially block-shaped or cylindrical and is formed in such a way that the lock striker is strain hardened.

Preferably the starter blank is formed to a shape closely representing the final shape during forming. The formed starter blank then essentially corresponds to the final form of the lock striker after the forming process. Openings such as holes in the base plate and the hole in the lock bracket can generally be produced during the forming process or during subsequent steps by stamping or cutting, as required.

A key element is forming of the starter blank to a one-piece lock striker from an essentially block-shaped or cylindrical starter blank to systematically form a fit-for-purpose lock striker that can also be easily produced. Using the suggested method, the mechanical characteristics of the lock striker can be specifically set to provide very specific application characteristics of a thus produced lock striker. Cold forming causes a further increase in strength also referred to as strain hardening. Consequently, materials can be used for the starter blank that in their original state have a lower strength and which when formed to a lock striker can withstand higher stressing due to the cold hardening, without high-value materials having to be used as starter blank.

As a result of the specific form of the starter blanks, the forming forces required for cold forming can be specifically reduced so that high tool stressing is advantageously minimized. Machines required for production, such as presses can be suitably reduced in size, resulting in an optimized production.

The blank is preferably formed by cold upsetting or cold extrusion. Most of the starter blank is used during forming, resulting in considerable material savings in particular compared to machining. The starter blank therefore preferably has the same volume as the formed lock striker. Cold forming processes such as cold upsetting or cold extrusion also only require particularly short production cycles even for complex formed parts, as the entire blank volume is formed simultaneously or in several forming stages into a shape closely representing the final shape.

In one embodiment of the invention, a wire or profile wire is used as the starter blank and preferably with a cross sectional area of 450 mm² to 1125 mm². For processing to a starter blank using the suggested method, wires or profile wires can be suitably processed in a simple manner by sheering or sawing. The specific selection of the cross sectional area for a wire or profile wire contributes to cold forming such as cold upsetting or cold extrusion producing lock strikers with optimised strength and fatigue strength values.

In one embodiment, the starter blank has a width of 15 mm to 25 mm and/or a length of 30 mm to 45 mm. In case of an essentially cylindrical starter blank, the diameter is preferably 15 mm to 35 mm. In a further preferred embodiment the starter blank is at least 25 mm and preferably 25 mm to 45 mm high. Trials have shown that starter blanks with such dimensions are particularly suitable for the suggested method and produce particularly good results as regards mechanical characteristics and application characteristics of the lock holder.

In order to achieve a favourable hardening effect in the lock striker, the main change in shape during forming is, in one embodiment, essentially vertical to the cross-sectional area or to the profile surface of the starter blank. The cross-sectional area or the profile surface is generally defined by the width and length and by the diameter in case of essentially cylindrical starter blanks. The change of the main shape considerably affects the hardening effect during forming so that the strain hardening of the lock striker is suitably optimized.

Depending on the arrangement of the starter blank the diameter of the base plate is preferably 40 mm to 80 mm and preferably 50 mm. Preferably, the base plate contains at least two openings in form of holes for fixing the lock striker. The openings are preferably provided on the edge of the base plate to allow sturdy fixing to, for instance, the body of a vehicle.

Openings in the base plate and/or a hole in the lock bracket can already be formed by special tool inserts during forming. Alternatively it is possible to add the openings and hole during a separate process step by, for instance, stamping or cutting.

Trials have shown that the suggested method is particularly suitable where tempering steel is used as material for the starter blanks. Advantageous steel types are: 38Cr2, 46Cr2, 34Cr4, 34CrS4, 37Cr4, 37CrS4, 41 Cr4, 41 CrS4, 25CrMo4, 25CrMoS4, 34CrMo4, 34CrMoS4, 42CrMo4, 42CrMoS4, 50CrMo4, 34CrNiMo6, 30CrNiMo8, 35NICr6, 36NiCrMo16, 39NiCrMo3, 30NiCrMo16-6, 51 CrV4.

In order to increase in particular the yield point and strength, the use of manganese and boron-alloyed steel such as 20MnB5, 30MnB5, 38MnB5, 27MnCrB5-2, 33MnCrB5-2 and 39MnCrB6-2 is particularly advantageous.

Generally the use of cold upset or cold extruded steel has proven to be advantageous, in particular in form of wire. Advantageous steel types are: Cq 22 (material number: 1.1152), C35EC, C35RC, C45EC, C45RX, 37Mo2, 38Cr2, 46Cr2, 34Cr4, 37Cr4, 41 Cr4, 41 CrS4, 25CrMo4, 25CrMoS4, 34CrMo4, 37CrMo4, 42CrMo4, 42CrMoS4, 34CrNiMo6, 41 NiCrMo7-3-2.

In order to provide, in particular, a high-strength lock striker, boron-alloyed steel is used. Particularly advantageous is the use of: 17B2, 23B2, 28B2, 33B2, 38B2, 17MnB4, 20MnB4, 23MnB4, 27MnB4, 30MnB4, 36MnB4, 37MnB5, 30MoB1, 32CrB4, 36CrB4, 31 CrMoB2-1.

Lock bracket and base plate are, in particular, produced as one piece during forming. In order to correctly design the lock bracket in accordance with the requirements, a reinforced transition area is provided between the base plate and lock bracket in a preferred embodiment. The reinforcement of the transition area increases the load-bearing capacity of the lock bracket, so that the lock striker is able to absorb higher loads.

Preferably, the forming process of the starter blank is carried out in several steps or stages. Depending on the requirements, the forming process can contain two or more steps or stages. In case of cold upsetting, preferably tapering and where applicable initial upsetting and finally finish upsetting is carried out in order to prevent inadmissible form changes and in particular material separations at individual points and allow flowing during forming of the material.

In order to influence properties such as strength, hardness and extension and to reduce inherent stresses in the formed lock striker, the lock striker is subjected to heat treatment and, in particular, tempering, in one embodiment. Preferably the lock striker is in this case subjected to a defined time-temperature sequence, coupled where applicable with additional chemical or mechanical influences. Depending on the requirements and material used, the tensile strength of the lock striker can be further increased by suitable heat treatment. By heat treating formed lock strikers, tensile strengths in excess of 30 kN can be achieved.

In order to further improve surface characteristics such as dimensional accuracy, surface treatment such as, in particular, flat embossing, smooth embossing or coin sizing is added to the forming process of the lock striker in a further embodiment of the method. It is also possible to specifically rework certain parts of the lock striker by surface treatment. A special surface structure, such as grooves or knurling can, for instance, be provided in the area in contact with the rotary latch of a lock in the installed state of the lock striker in order to prevent unwanted noises, such as e.g. creaking.

In order to ensure that the lock striker is sufficiently stable, the thickness of the lock bracket is preferably at least twice the thickness of the base plate. The lock striker is then best designed to meet operational stresses. The thickness of the base plate is preferably 1 mm, so for instance 3 mm on average.

Below the invention is explained in detail with reference to embodiment examples, in which:

### BRIEF DESCRIPTION OF THE DRAWINGS

FIG. 1 shows a perspective view of the lock striker

FIG. 2 shows a side and top view (a) as well as a further side view (b) of a lock striker.

FIG. 3 shows a schematic representation of starter blanks (a, b).

### DETAILED DESCRIPTION OF THE DRAWINGS

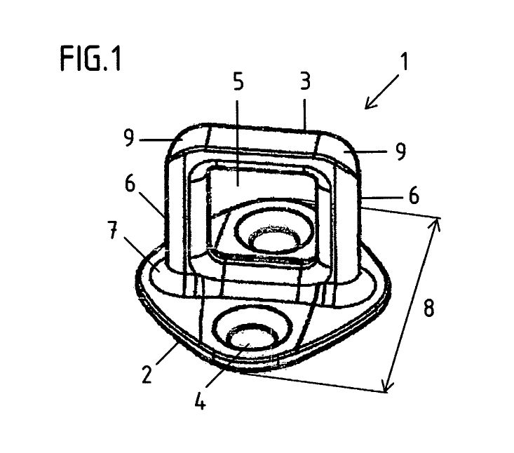

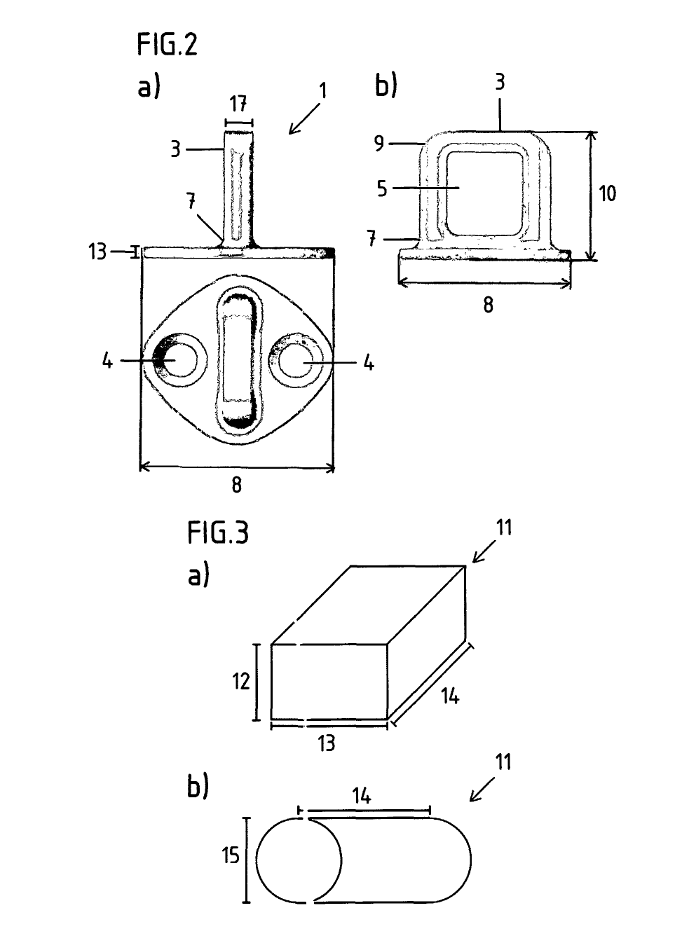

The lock striker 1 shown in FIG. 1 to FIG. 2 shows a typical application for the suggested solution. Below, the suggested solution is explained with reference to a lock striker for a motor vehicle lock. The invention is, however, not limited to this.

The lock striker shown in FIG. 1 contains a base plate 2 and a lock bracket 3. The lock bracket 3 has an opening 5 at its centre, allowing engagement with a rotary latch of a lock when installed. Using respective tools, the opening 5 can already be produced during forming of the starter blank 11 or can be produced during a subsequent work step, such as by stamping or machining. The lock bracket 3 contains two legs at both sides of the opening 5, which are in contact with the base plate 2. In this case, the base plate 2 contains two holes 4 in form of drilled holes, having a cone shape and allowing fixing to, in particular, a body of a vehicle. The area between the base plate 2 and lock bracket 3, i.e. the base plate/lock bracket transition 7, is preferably reinforced in order to provide a sturdier design. In the upper section of the lock bracket 3 and at the transitions to the respective legs 6, lock bracket/leg transitions 9 preferably have transition radii, in order to suitably optimize the production of the lock striker 1 for reducing stressing of the tool. The rounded bracket/leg transitions 9 are particularly advantageously produced during cold forming. Depending on the shape of the starter blank 11, the diameter of the base plate 2 is in particular not larger than 50 mm or alternatively 60 mm to 80 mm.

As apparent from FIG. 2a), the holes 4 are arranged, in particular, at the edges and on opposite sides of the base plate 2. In this case the holes are positioned at a distance of 30 mm to each other. The thickness 13 of the base plate 2 is preferably at least 3 mm, preferably 5 mm and even more preferably 4 mm. For a design with a stable connection with the lock bracket 3, the base plate/lock bracket transition 7 is reinforced so that the thickness of the base plate 2 is higher in this area. The thickness 14 of the lock bracket 3 is preferably greater than the thickness 13 of the base plate 2 and is preferably twice as thick in order to ensure an adequate force absorption by the lock bracket 3.

FIG. 2b) shows how the thickness 13 of the base plate 2 increases in the base plate/lock bracket transition 7. The height 10 of the lock bracket 3 is preferably smaller than the diameter 8 of the base plate. In particular, the height 10 of the lock brackets does not exceed 50 mm and is, for instance 34 mm.

Of particular significance is in this case the production method of the lock striker 1 shown in FIG. 1 to FIG. 2. According to this production method the starter blank 11 is essentially block-shaped or cylindrical and in such a way that the cold forming is a strain hardening.

The starter blank 11 is preferably a wire or profile wire that is cold upset or cold pressed. Preferably, the starter blank has a square, rectangular or round profile, with this list not being exhaustive but containing any forms relevant for the production process, such as oval profiles. As a result of the suitably dimensioned starter blank 11a specific cold forming is carried out that is associated with an increase in the strength of the lock striker 1, without unwanted high tool stressing.

Based on this, FIG. 3d) shows an essentially block-shaped starter blank. The width 12 of the starter blank 11 is preferably 15 mm to 35 mm. The length 13 is preferably 30 mm to 45 mm. The height 14 is preferably 25 mm to 45 mm. The cross-sectional area or the profile surface of the starter blank 11 is derived from the width 12 and length 13 of the starter blank 11. The lock striker 1 formed therefrom, preferably contains a base plate 2 with a diameter of no more than 50 mm.

FIG. 3b) shows an essentially cylindrical starter blank 11. The diameter 15 of the starter blank 11 is preferably 15 mm to 35 mm. The cross-sectional area or the profile surface of the starter blank 11 is determined by the diameter 15. The height 14 is preferably 30 mm to 60 mm. The formed lock striker 1 does in this case preferably have a diameter of 60 mm to 80 mm, such as 70 mm.

It has shown that lock strikers 1 produced in this way withstand the respective tensile forces. The lock strikers thus withstand a tensile load of 22 kN without the lock strikers having undergone additional heat treatment. After forming, the mechanical strength is furthermore at approx. 740 MP0 to 835 MPa.

Particularly good results have also been achieved by heat treatment of the lock striker, for instance by tempering. The thus tempered lock strikers 1 withstand a tensile load of at least 30 kN. The mechanical strength is then approx. 920 MPa to 990 MPa. By undergoing suitable heat treatment, in particular tempering, the produced lock strikers 1 can meet particularly high requirements.

1. Method for production of one-piece lock striker (1) in particular for a motor vehicle lock, in which the lock striker (1) comprises a base plate (2) and a lock bracket (3) and in which the lock striker is formed from a metal starter blank (11) by cold forming, in particular cold upsetting, characterized in that, the starter blank (11) is substantially block shaped or cylindrical and is formed in such a way that the lock striker (1) becomes strain hardened.

2. Method according to claim 1 in which an, in particular, cold upset or cold pressed wire or profile wire is used as starter blank (11) with preferably a cross sectional area or profile area of 450 mm² to 1125 mm^{2.}

3. Method according to claim 2, in which the starter blank (11) has a width (12) of 15 mm to 25 mm and/or a length (13) of 30 mm to 45 mm or the starter blank (11) has a diameter (15) of 15 mm to 35 mm.

4. Method according to claim 3, in which the starter blank (1) has a height of at least 25 mm and preferably of 25 mm to 45 mm.

5. Method according to claim 4, in which the forming is carried out in several step or stages and preferably in no more than three steps or stages.

6. Method according to claim 5, in which after forming also heat treatment is added and, in particular, tempering.

7. Method according to claim 6, in which the main change to the shape during forming is vertical to the cross sectional area or the profile area of the starter blank (11).

8. Method according to claim 7, in which the tempered steel and in particular a boron-alloyed steel is used as material for the starter blank (11).

9. Method according to claim 8, in which the material for the starter blank (11) is a tempered steel such as 38Cr2, 46Cr2, 34Cr4, 34CrS4, 37Cr4, 37CrS4, 41 Cr4, 41 CrS4, 25CrMo4, 25CrMoS4, 34CrMo4, 34CrMoS4, 42CrMo4, 42CrMoS4, 50CrMo4, 34CrNiMo6, 30CrNiMo8, 35NiCr6, 36NiCrMo16. 39NiCrMo3 30NiCrMo16-6, 51 CrV4 and preferably 20MnB5, 30MnB5, 38MnB5, 27MnCrB5-2, 33MnCrB5-2, 39MnCrB6-2 or a cold upset steel, such as Cq 22 (material number 1.1152), C35EC, C35RC, C45EC, C45RX, 37MO2, 38Cr2, 46Cr2, 34Cr4, 37Cr4, 41 Cr4, 41 CrS4, 25CrMo4, 25CrMoS4, 34CrMo4, 37CrMo4, 42CrMo4, 42CrMoS4, 34CrNiMo6, 41 NiCrMo7-3-2, and even more preferred 17B2, 23B2, 28B2, 33B2, 38B2, 17MnB4, 20MnB4, 23MnB4, 27MnB4, 30MnB4, 36MnB4, 37MnB5 30MoB1, 32CrB4, 36CrB4, 31 CrMoB2-1.

10. Lock striker for a motor vehicle lock produced according to the method of claim 9, in which the thickness (13) of the base plate is preferably at least 3 mm and even more preferably 3 to 5 mm.

11. Lock striker according to claim 10 in which the thickness (17) of the lock bracket exceeds the thickness (13) of the base plate and is preferably at least twice as thick.

12. Method according to claim 1, in which the starter blank (11) has a width (12) of 15 mm to 25 mm and/or a length (13) of 30 mm to 45 mm or the starter blank (11) has a diameter (15) of 15 mm to 35 mm.

13. Method according to claim 1, in which the starter blank (1) has a height of at least 25 mm and preferably of 25 mm to 45 mm.

14. Method according to claim 1, in which the forming is carried out in several step or stages and preferably in no more than three steps or stages.

15. Method according to claim 1, in which after forming also heat treatment is added and, in particular, tempering.

16. Method according to claim 1, in which the main change to the shape during forming is vertical to the cross sectional area or the profile area of the starter blank (11).

17. Method according to claim 1, in which the tempered steel and in particular a boron-alloyed steel is used as material for the starter blank (11).

18. Method according to claim 1, in which the material for the starter blank (11) is a tempered steel such as 38Cr2, 46Cr2, 34Cr4, 34CrS4, 37Cr4, 37CrS4, 41 Cr4, 41 CrS4, 25CrMo4, 25CrMoS4, 34CrMo4, 34CrMoS4, 42CrMo4, 42CrMoS4, 50CrMo4, 34CrNiMo6, 30CrNiMo8, 35NiCr6, 36NiCrMo16. 39NiCrMo3 30NiCrMo16-6, 51 CrV4 and preferably 20MnB5, 30MnB5, 38MnB5, 27MnCrB5-2, 33MnCrB5-2, 39MnCrB6-2 or a cold upset steel, such as Cq 22 (material number 1.1152), C35EC, C35RC, C45EC, C45RX, 37MO2, 38Cr2, 46Cr2, 34Cr4, 37Cr4, 41 Cr4, 41 CrS4, 25CrMo4, 25CrMoS4, 34CrMo4, 37CrMo4, 42CrMo4, 42CrMoS4, 34CrNiMo6, 41NiCrMo7-3-2, and even more preferred 17B2, 23B2, 28B2, 33B2, 38B2, 17MnB4, 20MnB4, 23MnB4, 27MnB4, 30MnB4, 36MnB4, 37MnB5 30MoB1, 32CrB4, 36CrB4, 31CrMoB2-1.

19. Lock striker for a motor vehicle lock produced according to the method of claim 1, in which the thickness (13) of the base plate is preferably at least 3 mm and even more preferably 3 to 5 mm.

20. Lock striker according to the method of claim 1 in which the thickness (17) of the lock bracket exceeds the thickness (13) of the base plate and is preferably at least twice as thick.
